(19) United States
(12) Patent Application Publication
(10) Pub. No.: US 2025/0390634 A1
(43) Pub. Date: Dec. 25, 2025

(54) QUANTITATIVE ENERGY ABSORPTION PREVENTION AND CONTROL DESIGN METHOD FOR ROCK BURST

(71) Applicant: Northeastern University, Shenyang City (CN)

(72) Inventors: Benguo HE, Shenyang City (CN); Hongpu LI, Shenyang City (CN); Xiating FENG, Shenyang City (CN); Xiangrui MENG, Shenyang City (CN); Jie WANG, Shenyang City (CN)

(21) Appl. No.: 18/861,815

(22) PCT Filed: May 29, 2024
(86) PCT No.: PCT/CN2024/095895

§ 371 Date: Oct. 30, 2024

(30) Foreign Application Priority Data
May 30, 2023 (CN) 202310626155.5

(51) Int. Cl. G06F 30/23; G06F 111/10

(52) U.S. Cl. CPC G06F 30/23; G06F 2111/10

(57) ABSTRACT

A quantitative energy-absorption prevention and control design method includes: establishing a numerical calculation model, and performing a simulation calculation on excavation; determining a location and a range of rock-burst damage and a depth of a burst pit and providing an energy release amount at different positions; determining a location, a direction, and a dip angle of a structural plane; determining a design length of a free section of anchor rods, and in combination with a design anchoring force of the anchor rods, determining an optimal length of a single anchor rods; calculating ejection kinetic energy of rock blocks; and determining a length of an anchoring section of the anchor rod, a total length of the anchor rods, and a number of the anchor rods, such that a total energy absorbing capacity of all anchor rods is greater than the ejection kinetic energy at a time of the rock burst.

### FIELD OF THE INVENTION

The present invention relates to the technical field of prevention and control safety for a rock burst in underground engineering, and in particular to a quantitative energy-absorption prevention and control design method for a rock burst.

### THE PRIOR ARTS

A rock burst is a geological hazard caused by rapid release of elastic strain energy stored in surrounding rocks during excavation, which has the effect of impact kinetic energy. Due to the suddenness of an occurrence process and the severity of its consequences, the rock burst has become a common concern in deep underground engineering both domestically and internationally. With the development of underground engineering such as railways, highways, and hydropower towards the deep earth, construction of a large number of tunnels with high geostress and hard surrounding rocks has made rock-burst problems more prominent. In order to reduce the risk of rock-burst disasters during construction of underground engineering and ensure construction safety, there is an urgent need to develop quantitative energy-absorption prevention and control principles and design methods for the rock burst.

At present, in the design of deep buried hard-rock high geostress tunnels, the energy fracture criterion based on a strain energy theory has significant advantages in dealing with complex geostress states. Thus, it is widely used for rock-burst assessment in tunnel design. A rock-burst failure process is a dynamic instability failure process, which releases a large amount of accumulated elastic strain energy, accompanied by conversion from elastic strain energy to residual strain energy, ejection kinetic energy, and shear sliding dissipated energy. Herein, the ejection kinetic energy is one of important indicators for evaluating the degree of the rock-burst disasters. The quantification of various kinds of impact energy, especially the quantification of the ejection kinetic energy, can provide an important basis for quantitative design of support structures in prevention and control for the rock burst. In terms of control for energy of the rock burst, those skilled in the art have designed and developed a wide variety of energy absorbing anchor rods. When reinforced surrounding rocks are subjected to impact loads, the energy absorbing anchor rods can generate significant deformation while maintaining a certain bearing capacity, without causing the energy absorbing anchor rods to break, thereby continuing to support loosened and fractured rock masses. However, there is still a lack of reliable design basis and methods for the length (of an anchoring section, and a free section) and quantity of the energy absorbing anchor rods in the specific design. Therefore, there is an urgent need to develop a scientific active energy-absorbing control technology for a rock burst.

### SUMMARY OF THE INVENTION

The technical problem to be solved by the present invention is to provide a quantitative energy-absorption prevention and control design method for a rock burst in response to the defects in the prior art, and to design a support scheme using energy absorbing anchor rods.

To solve the above technical problems, the present invention is to provide the quantitative energy-absorption prevention and control design method for a rock burst including the following steps:

Step 1: according to an excavation and support design scheme for underground engineering, establishing a finite element numerical calculation model for the underground engineering, and performing a simulation calculation on an excavation of the underground engineering.

Step 1-1: during the numerical calculation analysis, setting a value according to actual geostress data, calculating an initial geostress field, and selecting an elastic-brittle-plastic constitutive model.

Step 1-2: according to indoor rock mechanics tests or using a back analysis method, determining rock mass constitutive parameters required for the numerical calculation.

Step 2: considering a local energy release rate (LERR) in an simulation calculation process of the excavation of the underground engineering, and extracting results of the local energy release rate (LERR) after the simulation calculation are completed, according to an LERR value, determining a location and a range of rock-burst damage, as well as a depth of a burst pit of a rock burst, and quantitatively providing an energy release amount at different positions of the rock bursts.

Step 2-1: determining a local energy release rate (LERR) index, as shown in the following formula:

$${LERR}_{i} = {U}_{i max} - {U}_{i min}$$

$${U}_{i max} = \frac{{σ}_{1}^{2} + {σ}_{2}^{2} + {σ}_{3}^{2} - 2 v ( {σ}_{1} {σ}_{2} + {σ}_{2} {σ}_{3} + {σ}_{1} {σ}_{3} )}{2 E}$$

$${U}_{i min} = \frac{{σ}_{1}^{′2} + {σ}_{2}^{′2} + {σ}_{3}^{′2} - 2 v ( {σ}_{1}^{′} {σ}_{2}^{′} + {σ}_{2}^{′} {σ}_{3}^{′} + {σ}_{1}^{′} {σ}_{3}^{′} )}{2 E}$$

Wherein, LERRᵢ is a local energy release rate of an i^{th} unit; Uᵢₘₐₓ is a peak value of elastic strain energy density before a brittle failure of the i^{th} unit; Uᵢₘᵢₙ is a valley value of the elastic strain energy density after the brittle failure of the i^{th} unit; σ₁, σ₂ and σ₃ are tensors of a maximum stress, an intermediate stress, and a maximum principal stress corresponding to a peak value of unit strain energy, respectively;

$${σ}_{1}^{′} , {σ}_{2}^{′} and {σ}_{3}^{′}$$

are tensors of a maximum stress, an intermediate stress, and a maximum principal stress corresponding to a valley value of unit strain energy, respectively; ν is a Poisson's ratio of surrounding rocks; and E is an elastic modulus of the surrounding rocks.

Step 2-2: counting LERR values of tunnel surrounding rocks at different locations and tunnel wall depths, and according to the LERR values, determining the location, a damage area, and the depth of the burst pit, and providing intensity of energy release, wherein an energy release area is a potential rock-burst area.

Step 3: according to an advanced geological exploration of a site of the underground engineering, determining a location, a direction, and a dip angle of a structural plane.

Step 4: according to the locations of the rock burst, the depth of the burst pit, and the location of the structural plane, determining a design length of a free section of energy absorbing anchor rods, and in combination with a design anchoring force of the energy absorbing anchor rods and considering a space size of the excavation of the underground engineering, determining an optimal length of a single energy absorbing anchor rod.

Step 4-1: the free section of the energy absorbing anchor rods penetrates through the burst pit, and a length of the free section of the energy absorbing anchor rod is greater than an estimated depth of the burst pit, such that the energy absorbing anchor rods can extend freely and play an energy absorbing role in an event of the rock burst.

Step 4-2: the free section of the energy absorbing anchor rods penetrates through the structural plane that controls the rock burst, and play a role of a pin to prevent relative sliding of the rock blocks on two sides of the structural plane, and the length of the free section of the energy absorbing anchor rods is greater than a distance from the structural plane to a tunnel wall.

Step 4-3: a maximum length of the free section of the energy absorbing anchor rods is selected from results obtained in steps 4-1 and 4-2.

Step 4-4: when the length of the free section of the energy absorbing anchor rods is determined, performing indoor tests on static and impact tensile strength of the energy absorbing anchor rods with different anchoring lengths, different anchoring materials, different rod sizes, and different rod materials to determine elongation, yield strength, fracture strength, and an energy absorbing capacity of the energy absorbing anchor rods, and determine the optimal length of the energy absorbing anchor rods.

Step 5: calculating ejection kinetic energy of rock blocks of the rock burst by using discontinuous deformation software.

Step 5-1: determining an energy conversion situation during a rock-burst process.

The rock-burst process involves complex energy conversion of surrounding rocks, a total elastic strain energy before the excavation is converted into residual strain energy, dissipated energy, and ejection kinetic energy after the rock burst occurs, as shown in the following formula:

$${U}^{o} = {U}_{e}^{*} + {U}_{k}^{*} + {U}_{d}^{*}$$

Wherein, U^{o} is the total elastic strain energy before excavation;

$${U}_{e}^{*}$$

is the residual strain energy after the excavation;

$${U}_{k}^{*}$$

is the dissipated energy during the excavation process; and

$${U}_{d}^{*}$$

is the ejection kinetic energy after the excavation.

Step 5-2: calculating the ejection kinetic energy generated by the rock burst.

The ejection kinetic energy generated by the rock burst is shown in the following formula:

$${U}_{d}^{*} = {\sum }_{i = 1}^{n} \frac{1}{2} {m}_{i} {v}_{i}^{2}$$

Wherein,

$${U}_{d}^{*}$$

is the total ejection kinetic energy of an area affected by the rock burst after the excavation; n is a number of blocks in the area affected by the rock burst after the excavation; mᵢ is a mass of the ith block; νᵢ is an ejection velocity of the ith block during the rock burst.

Step 6: according to parameters for an optimal energy absorbing anchor rod selected in step 4 and the ejection kinetic energy generated by the rock burst obtained in step 5, determining a length of an anchoring section of the energy absorbing anchor rod, a total length of the energy absorbing anchor rods, and a number of the energy absorbing anchor rods, such that a total energy absorbing capacity of all the energy absorbing anchor rods is greater than the ejection kinetic energy at a time of the rock burst, as shown in the following formula:

$$W \times S > {U}_{d}^{*}$$

Wherein, W is an energy absorbing capacity of a single energy absorbing anchor rod, in kJ; S is a minimum number of the energy absorbing anchor rods required within a rock-burst range, in pieces; and

$${U}_{d}^{*}$$

is the total ejection kinetic energy of the area affected by the rock burst after the excavation, in kJ.

The beneficial effects of adopting the above technical solution are: according to the quantitative prevention and control design method for a rock burst provided by the present invention, a quantitative design method and process for energy absorbing anchor rods are provided, providing a design basis for scientific design of energy-absorption prevention and control for the rock burst, and solving the problem of aimlessness in the problem of energy-absorption prevention and control design for the rock burst in underground engineering. The present invention provides a method for quantitatively calculating ejection kinetic energy of a rock burst, and provides a design method for energy absorbing anchor rods from the perspective of energy. By determining the location, the damage area, and the depth of the burst pit, combined with the location of the structural plane, the design length of the free section of the energy absorbing anchor rods can be determined, which can avoid the problems of low elongation and insufficient energy absorbing capacity in traditional anchor rod design.

### BRIEF DESCRIPTION OF DRAWINGS

FIG. 1 is a flowchart of a quantitative energy-absorption prevention and control design method for a rock burst provided by an embodiment of the present invention;

FIG. 2 is a schematic diagram of a gradually decoupled energy absorbing anchor rod provided by an embodiment of the present invention;

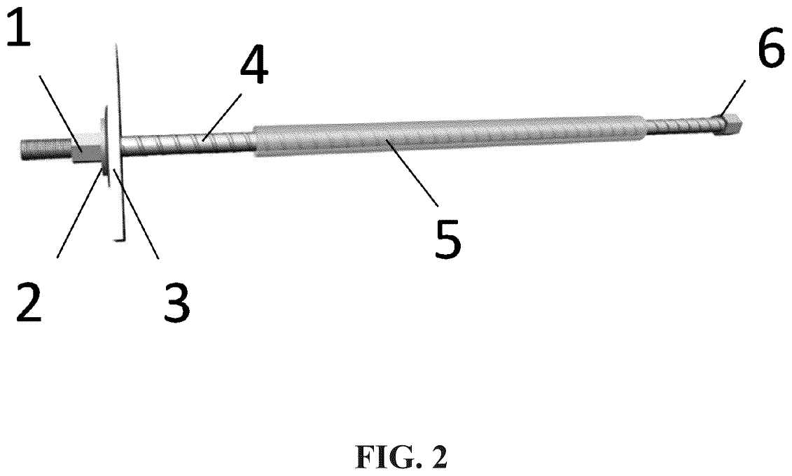

FIG. 3 is a schematic diagram of a numerical calculation model for a tunnel provided by an embodiment of the present invention;

FIGS. 4(a) and 4(b) are schematic diagrams of an estimated rock-burst area by a local energy release rate index provided by an embodiment of the present invention, where FIG. 4(a) is a result diagram of the local energy release rate index, and FIG. 4(b) is a schematic diagram of a depth of a burst pit of the rock burst;

FIG. 5 is a performance test diagram of a gradually decoupled energy absorbing anchor rod provided by an embodiment of the present invention; and

FIG. 6 is a schematic diagram of calculating ejection kinetic energy of a rock burst by using discontinuous deformation software provided by an embodiment of the present invention.

In FIGS.: 1: nut; 2: gasket; 3: backing plate; 4: anchor rod body; 5: gradually decoupled material; 6: anchor head; 7: potential rock-burst area determined by an LERR index; 8: actual rock-burst area; 9: rock-burst ejection block.

### DETAILED DESCRIPTION OF THE PREFERRED EMBODIMENT

The specific embodiments of the present invention are further described in detail with reference to the accompanying drawings and embodiments. The following embodiments are used to illustrate the present invention, but not to limit the scope of the present invention.

In the embodiment, a circular tunnel is taken as an example, a quantitative energy-absorption prevention and control design method for a rock burst is used as a support scheme using energy absorbing anchor rods for the rock burst. In the embodiment, an energy absorbing anchor rod is a gradually decoupled energy absorbing anchor rod, which includes a nut 1, a gasket 2, a backing plate 3, an anchor rod body 4, a gradually decoupled material 5, and an anchor head 6.

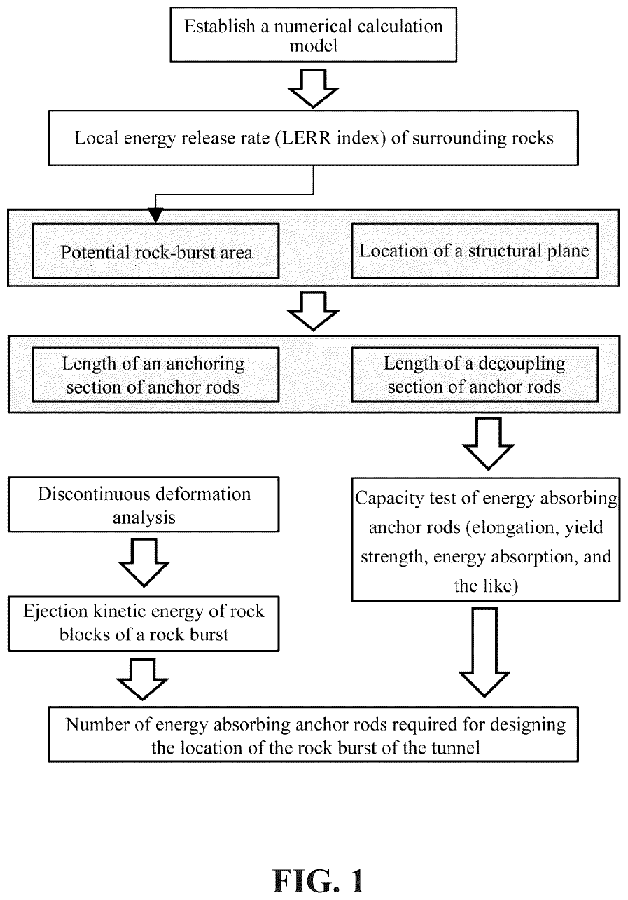

In the embodiment, the quantitative energy-absorption prevention and control design method for a rock burst, as shown in FIG. 1, includes the following steps:

Step 1: according to an excavation and support design scheme for underground engineering, a finite element numerical calculation model for the underground engineering is established, and a simulation calculation is performed on an excavation of the underground engineering.

Step 1-1: during numerical calculation analysis, a value is set according to actual geostress data, an initial geostress field is calculated, and an elastic-brittle-plastic constitutive model is selected.

Step 1-2: according to indoor rock mechanics tests or using a back analysis method, rock mass constitutive parameters required for the numerical calculation are determined.

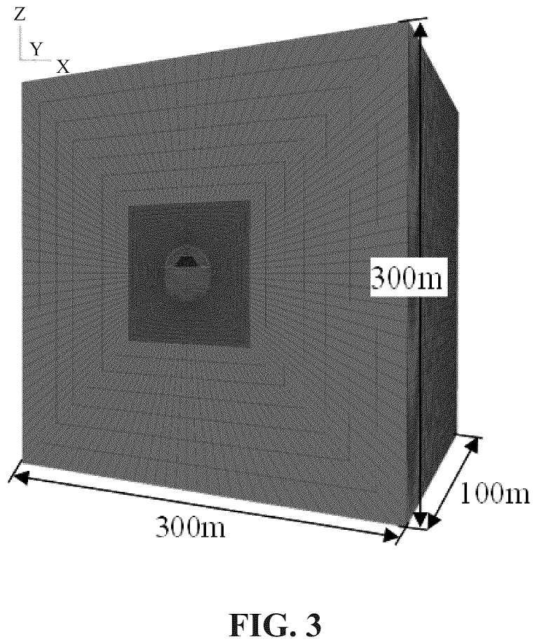

In the embodiment, a numerical calculation model for the tunnel is established, as shown in FIG. 3. A rock mass selects an elastic-brittle-plastic constitutive strain hardening (CWFS) model, and the values of the surrounding rock parameters are shown in Table 1.

TABLE 1
Mechanics parameters table of surrounding rocks

| E/ | | c₀/ | c_{d}/ | | | σ^{t}/ | | ε̅_{c}^{p}/ | ε̅_{ϕ}^{p}/ |
|---|---|---|---|---|---|---|---|---|---|
| GPa | ν | MPa | MPa | ϕ₀/° | ϕ_{d}/° | MPa | ψ/° | 10⁻³ | 10⁻³ |
| 25 | 0.25 | 12 | 2 | 20 | 45 | 2.5 | 12 | 2 | 4 |

In the table, E is an elastic modulus of the surrounding rocks; ν is a Poisson's ratio of the surrounding rocks; c₀ and ϕ₀ are initial cohesion and an internal friction angle, respectively; c_{d} and ϕ_{d} are residual cohesion and an internal friction angle, respectively; ψ is an angle of dilation; σ^{t} is tensile strength; and

$${\overline{ε}}_{c}^{p} and {\overline{ε}}_{ϕ}^{p}$$

are equivalent plastic strain threshold values for the cohesion and the internal friction angle entering a residual section.

Step 2: a local energy release rate (LERR) is considered in an simulation calculation process of the excavation of the underground engineering, results of the local energy release rate (LERR) are extracted after the simulation calculation is completed, according to an LERR value, a location and a range of rock-burst damage, as well as a depth of a burst pit of a rock burst are determined, and an energy release amount at different positions of the rock bursts is quantitatively provided.

Step 2-1: a local energy release rate (LERR) index is determined, as shown in the following formula:

$${LERR}_{i} = {U}_{im ax} - {U}_{imin}$$

$${U}_{imax} = \frac{{σ}_{1}^{2} + {σ}_{2}^{2} + {σ}_{3}^{2} - 2 v ( {σ}_{1} {σ}_{2} + {σ}_{2} {σ}_{3} + {σ}_{1} {σ}_{3} )}{2 E}$$

$${U}_{imin} = \frac{{σ}_{1}^{′2} + {σ}_{2}^{′2} + {σ}_{3}^{′2} - 2 v ( {σ}_{1}^{′} {σ}_{2}^{′} + {σ}_{2}^{′} {σ}_{3}^{′} + {σ}_{1}^{′} {σ}_{3}^{′} )}{2 E}$$

Wherein, LERRᵢ is a local energy release rate of an i^{th} unit; Uᵢₘₐₓ is a peak value of elastic strain energy density before a brittle failure of the i^{th} unit; Uᵢₘᵢₙ is a valley value of elastic strain energy density after brittle failure of the i^{th} unit; σ₁, σ₂ and σ₃ are tensors of a maximum stress, an intermediate stress, and a maximum principal stress corresponding to a peak value of unit strain energy, respectively;

$${σ}_{1}^{′} , {σ}_{2}^{′} and {σ}_{3}^{′}$$

are tensors of a maximum stress, an intermediate stress, and a maximum principal stress corresponding to a valley value of unit strain energy, respectively; ν is a Poisson's ratio of surrounding rocks; and E is an elastic modulus of the surrounding rocks.

Step 2-2: LERR values of tunnel surrounding rocks at different locations and tunnel wall depths are counted, according to the LERR values, the location, a damage area, and the depth of the burst pit are determined, and intensity of energy release is provided, wherein an energy release area is a potential rock-burst area.

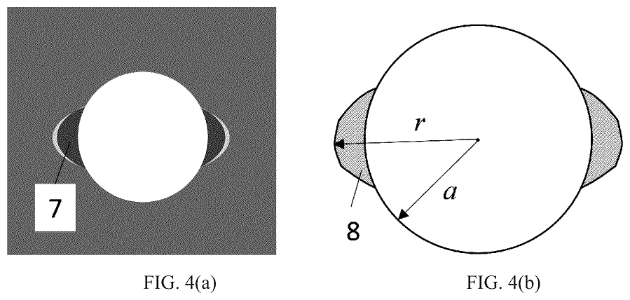

In the embodiment, the local energy release rate (LERR) index value is used to determine the location of rock-burst damage. It is estimated that the rock burst will mainly occur on the left and right sides of the tunnel, with a maximum depth of the burst pit during the rock burst about 1 m. The specific location and the range of the rock burst are as shown in FIGS. 4(a) and 4(b), wherein a represents a radius of the tunnel and r represents a distance from the depth of tunnel failure to the center of the tunnel.

Step 3: according to an advanced geological exploration of a site of the underground engineering, a location, a direction, and a dip angle of a structural plane are determined.

Step 4: according to the locations of the rock burst, the depth of the burst pit, and the location of the structural plane, a design length of a free section of energy absorbing anchor rods is determined, and in combination with a design anchoring force of the energy absorbing anchor rods and a space size of the excavation of the underground engineering is considered, an optimal length of a single energy absorbing anchor rod is determined.

Step 4-1: the free section of the energy absorbing anchor rods penetrates through the burst pit, and a length of the free section of the energy absorbing anchor rod is greater than an estimated depth of the burst pit, such that the energy absorbing anchor rods can extend freely and play an energy absorbing role in an event of the rock burst.

Step 4-2: the free section of the energy absorbing anchor rods penetrates through the structural plane that controls the rock burst, and play a role of a pin to prevent relative sliding of the rock blocks on two sides of the structural plane, and the length of the free section of the energy absorbing anchor rods is greater than a distance from the structural plane to a tunnel wall.

Step 4-3: a maximum length of the free section of the energy absorbing anchor rods is selected from results obtained in steps 4-1 and 4-2.

Step 4-4: when the length of the free section of the energy absorbing anchor rods is determined, performing indoor tests on static and impact tensile strength of the energy absorbing anchor rods with different anchoring lengths, different anchoring materials, different rod sizes, and different rod materials to determine elongation, yield strength, fracture strength, and an energy absorbing capacity of the energy absorbing anchor rods, and determine the optimal length of the energy absorbing anchor rods.

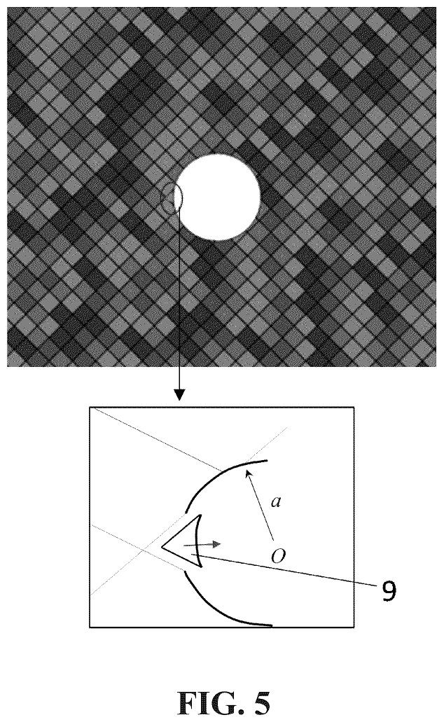

In the embodiment, according to the results of steps 2 and 3, an anchoring length of the gradually decoupled energy absorbing anchor rod is designed to be 1700 mm, a length of a decoupled section is 1300 mm, a total length of the energy absorbing anchor rods is 3 m, and the length of the designed decoupled section is greater than the estimated maximum depth of the burst pit of the rock burst. Indoor testing is performed on the energy absorbing anchor rods, a rod body 4 is threaded steel anchor rods made of HRB300, with a diameter of 22 mm, two nuts are directly used as an anchor head 6, and an anchoring agent is mortar. The gradually decoupled material 5 is a thermoplastic tube, and a contact surface between the inner surface of the gradually decoupled material 5 and the rod body 4 is lubricated with dry oil. A peak load of the energy absorbing anchor rod reaches 233 kN, and the maximum deformation generated by a non-anchored section of the rod body 4 reaches 240 mm, with an absorbed energy of about 48 kJ. The test results are as shown in FIG. 5.

Step 5: ejection kinetic energy of rock blocks of the rock burst is calculated by using discontinuous deformation software.

Step 5-1: an energy conversion situation during a rock-burst process is determined.

The rock-burst process involves complex energy conversion of surrounding rocks, a total elastic strain energy before the excavation is converted into residual strain energy, dissipated energy, and ejection kinetic energy after the rock burst occurs, as shown in the following formula:

$${U}^{o} = {U}_{e}^{*} + {U}_{k}^{*} + {U}_{d}^{*}$$

Wherein, U⁰ is the total elastic strain energy before the excavation;

$${U}_{e}^{*}$$

is the residual strain energy after the excavation;

$${U}_{k}^{*}$$

is the dissipated energy during the excavation process; and

$${U}_{d}^{*}$$

is the ejection kinetic energy after the excavation.

Step 5-2: the ejection kinetic energy generated by the rock burst is calculated.

The ejection kinetic energy generated by the rock burst is shown in the following formula:

$${U}_{d}^{*} = {\sum }_{i = 1}^{n} \frac{1}{2} {m}_{i} {v}_{i}^{2}$$

Wherein,

$${U}_{d}^{*}$$

is the total ejection kinetic energy of an area affected by the rock burst after the excavation; n is a number of blocks in the area affected by the rock burst after the excavation; mᵢ is a mass of the ith block; νᵢ is an ejection velocity of the ith block during the rock burst.

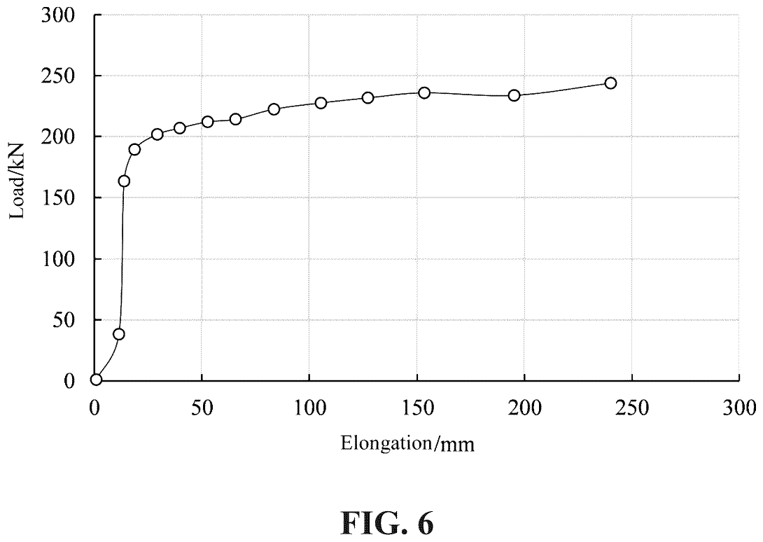

In the embodiment, the discontinuous deformation software DDA is used to calculate the ejection kinetic energy of rock blocks of the rock burst; the kinetic energy of blocks in an affected area can be obtained by adding the kinetic energy of all individual blocks in the affected area, and their velocities are recorded for points located at the center of mass of each block in discontinuous deformation software grid during measurement. The calculation of the ejection kinetic energy is shown as FIG. 6, which includes a rock-burst ejection block 9. Through calculation, it is found that the total ejection kinetic energy in the affected area during excavation of the tunnel is 414 kJ.

Step 6: according to parameters for an optimal energy absorbing anchor rod selected in step 4 and the ejection kinetic energy generated by the rock burst obtained in step 5, a length of an anchoring section of the energy absorbing anchor rod, a total length of the energy absorbing anchor rods, and a number of the energy absorbing anchor rods are determined, such that a total energy absorbing capacity of all the energy absorbing anchor rods is greater than the ejection kinetic energy at a time of the rock burst, as shown in the following formula:

$$W \times S > {U}_{d}^{*}$$

Wherein, W is an energy absorbing capacity of a single energy absorbing anchor rod, in kJ; S is a minimum number of anchor rods required within a rock-burst range, in pieces; and

$${U}_{d}^{*}$$

is the total ejection kinetic energy of the area affected by the rock burst after the excavation, in kJ.

In the embodiment, according to the test and calculation results in steps 4 and 5, when the energy absorbing capacity of the energy absorbing anchor rods is 48 kJ×9, it is greater than the total ejection kinetic energy of 414 kJ in the affected area for excavation of the tunnel. Thus, the number of gradually decoupled energy absorbing anchor rods required within the rock-burst area of each linear meter of an excavation section of the tunnel is greater than 9.

According to the embodiment, from the perspective of energy-absorption prevention and control for the rock burst, a complete design method and process are provided for the quantitative design of the gradually decoupled energy absorbing anchor rods, which provides an important design basis and support for the energy absorption prevention and control design of rock burst tunnels.

Finally, it should be noted that: the above embodiments are only used to illustrate the technical solution of the present invention but not to limit it; although the present invention has been described in detail with reference to the aforementioned embodiments, those skilled in the art should understand that: it is still possible to modify the technical solutions described in the aforementioned embodiments, or to replace some or all of the technical features equally; and these modifications or substitutions do not depart from the essence of the corresponding technical solution as defined by the claims of the present invention.

What is claimed is:

1. A quantitative energy-absorption prevention and control design method for a rock burst, comprising the following steps:
step 1: according to an excavation and support design scheme for underground engineering, establishing a finite element numerical calculation model for the underground engineering, and performing a simulation calculation on an excavation of the underground engineering;
step 2: considering a local energy release rate (LERR) in an simulation calculation process of the excavation of the underground engineering, and extracting results of the local energy release rate (LERR) after the simulation calculation is completed, according to an LERR value, determining a location and a range of rock-burst damage, as well as a depth of a burst pit of a rock burst, and quantitatively providing an energy release amount at different positions of the rock bursts;
step 3: according to an advanced geological exploration of a site of the underground engineering, determining a location, a direction, and a dip angle of a structural plane;
step 4: according to the locations of the rock burst, the depth of the burst pit, and the location of the structural plane, determining a design length of a free section of energy absorbing anchor rods, and in combination with a design anchoring force of the energy absorbing anchor rods and considering a space size of the excavation of the underground engineering, determining an optimal length of a single energy absorbing anchor rod;
step 5: calculating ejection kinetic energy of rock blocks of the rock burst by using discontinuous deformation software;
step 5-1: determining an energy conversion situation during a rock-burst process;
step 5-2: calculating the ejection kinetic energy generated by the rock burst; and
step 6: according to parameters for an optimal energy absorbing anchor rod selected in step 4 and the ejection kinetic energy generated by the rock burst obtained in step 5, determining a length of an anchoring section of the energy absorbing anchor rod, a total length of the energy absorbing anchor rods, and a number of the energy absorbing anchor rods, such that a total energy absorbing capacity of all the energy absorbing anchor rods is greater than the ejection kinetic energy at a time of the rock burst.

2. The quantitative energy-absorption prevention and control design method for a rock burst according to claim 1, wherein in step 1: during the numerical calculation, setting a value according to actual geostress data, calculating an initial geostress field, selecting an elastic-brittle-plastic constitutive model, and according to indoor rock mechanics tests or using a back analysis method, determining rock mass constitutive parameters required for the numerical calculation.

3. The quantitative energy-absorption prevention and control design method for a rock burst according to claim 2, wherein step 2 comprises the steps:
step 2-1: determining a local energy release rate (LERR) index, as shown in the following formula:
$${LERR}_{i} = {U}_{imax} - {U}_{imin}$$
$${U}_{imax} = \frac{{σ}_{1}^{2} + {σ}_{2}^{2} + {σ}_{3}^{2} - 2 v ( {σ}_{1} {σ}_{2} + {σ}_{2} {σ}_{3} + {σ}_{1} {σ}_{3} )}{2 E}$$
$${U}_{imin} = \frac{{σ}_{1}^{′2} + {σ}_{2}^{′2} + {σ}_{3}^{′2} - 2 v ( {σ}_{1}^{′} {σ}_{2}^{′} + {σ}_{2}^{′} {σ}_{3}^{′} + {σ}_{1}^{′} {σ}_{3}^{′} )}{2 E}$$
wherein, LERRᵢ is a local energy release rate of an i^{th} unit; Uᵢₘₐₓ is a peak value of elastic strain energy density before a brittle failure of the i^{th} unit; Uᵢₘᵢₙ is a valley value of the elastic strain energy density after the brittle failure of the i^{th} unit; σ₁, σ₂ and σ₃ are tensors of a maximum stress, an intermediate stress, and a maximum principal stress corresponding to a peak value of unit strain energy, respectively;
$${σ}_{1}^{′} , {σ}_{2}^{′} and {σ}_{3}^{′}$$
are tensors of a maximum stress, an intermediate stress, and a maximum principal stress corresponding to a valley value of the unit strain energy, respectively; ν is a Poisson's ratio of surrounding rocks; and E is an elastic modulus of the surrounding rocks; and
step 2-2: counting LERR values of tunnel surrounding rocks at different locations and tunnel wall depths, and according to the LERR values, determining the location, a damage area, and the depth of the burst pit, and providing intensity of energy release, wherein an energy release area is a potential rock-burst area.

4. The quantitative energy-absorption prevention and control design method for a rock burst according to claim 3, wherein step 4 comprises the steps:
step 4-1: the free section of the energy absorbing anchor rods penetrates through the burst pit, and a length of the free section of the energy absorbing anchor rod is greater than an estimated depth of the burst pit, such that the energy absorbing anchor rods can extend freely and play an energy absorbing role in an event of the rock burst;
step 4-2: the free section of the energy absorbing anchor rods penetrates through the structural plane that controls the rock burst, and play a role of a pin to prevent relative sliding of the rock blocks on two sides of the structural plane, and the length of the free section of the energy absorbing anchor rods is greater than a distance from the structural plane to a tunnel wall;
step 4-3: a maximum length of the free section of the energy absorbing anchor rods is selected from results obtained in steps 4-1 and 4-2; and
step 4-4: when the length of the free section of the energy absorbing anchor rods is determined, performing indoor tests on static and impact tensile strength of the energy absorbing anchor rods with different anchoring lengths, different anchoring materials, different rod sizes, and different rod materials to determine elongation, yield strength, fracture strength, and an energy absorbing capacity of the energy absorbing anchor rods, and determine the optimal length of the energy absorbing anchor rods.

5. The quantitative energy-absorption prevention and control design method for a rock burst according to claim 4, wherein in the rock-burst process described in step 5-1, a total elastic strain energy before the excavation is converted into residual strain energy, dissipated energy, and ejection kinetic energy after the rock burst occurs, as shown in the following formula:
$${U}^{o} = {U}_{e}^{*} + {U}_{k}^{*} + {U}_{d}^{*}$$
wherein, U⁰ is the total elastic strain energy before the excavation;
$${U}_{e}^{*}$$
is the residual strain energy after the excavation;
$${U}_{k}^{*}$$
is the dissipated energy during the excavation process; and
$${U}_{d}^{*}$$
is the ejection kinetic energy after the excavation.

6. The quantitative energy-absorption prevention and control design method for a rock burst according to claim 5, wherein the ejection kinetic energy generated by the rock burst is shown in the following formula:
$${U}_{d}^{*} = {\sum }_{i = 1}^{n} \frac{1}{2} {m}_{i} {v}_{i}^{2}$$
wherein,
$${U}_{d}^{*}$$
is the total ejection kinetic energy of an area affected by the rock burst after the excavation; n is a number of blocks in the area affected by the rock burst after the excavation; mᵢ is a mass of the i^{th} block; and νᵢ is an ejection velocity of the i^{th} block during the rock burst.

7. The quantitative energy-absorption prevention and control design method for a rock burst according to claim 6, wherein in step 6, the total energy absorbing capacity of all the energy absorbing anchor rods is greater than the ejection kinetic energy at the time of the rock burst, as shown in the following formula:
$$W \times S > {U}_{d}^{*}$$
wherein, W is an energy absorbing capacity of a single energy absorbing anchor rod; S is a minimum number of the energy absorbing anchor rods required within a rock-burst range; and
$${U}_{d}^{*}$$
is the total ejection kinetic energy of the area affected by the rock burst after the excavation.
